(19) United States
(12) Patent Application Publication
(10) Pub. No.: US 2010/0154516 A1
(43) Pub. Date: Jun. 24, 2010

(54) WATERPROOF TEST METHOD AND WATERPROOF TEST TANK

(75) Inventors: Ryo HATTORI, Kawasaki (JP); Takashi SUZUKI, Kawasaki (JP); Hidekatsu KOBAYASHI, Kawasaki (JP); Kouki MURAKAMI, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 12/631,328

(22) Filed: Dec. 4, 2009

(30) Foreign Application Priority Data
Dec. 24, 2008 (JP) 2008-328732

(51) Int. Cl. G01M 3/04

(52) U.S. Cl. 73/40.7

(57) ABSTRACT

A method for testing waterproof property of an object designed to prevent water from penetrating into the inside of the object and having a hole, the hole allowing air communication between the inside and the outside of the object, the method includes: attaching closely to the object a tank having an opening hermetically surrounding the hole to form an air communication path between the inside of the object and the tank to form a single air tight space; placing the object to which the tank is attached in an air tight container; either or both of injecting gas into and extracting the air from the air tight container containing the object so as to change the gaseous pressure of the air tight container; and measuring an internal gaseous pressure of the air tight container to determine whether the waterproof property of the object is effective or not.

### CROSS-REFERENCE TO RELATED APPLICATION

This application is based upon and claims the benefit of priority of the prior Japanese Patent Application No. 2008-328732, filed on Dec. 24, 2008, the entire contents of which are incorporated herein by reference.

### FIELD

A certain aspect of the embodiments discussed herein relates to a technique of a method for testing waterproof property of an object.

### BACKGROUND

Conventionally, a method for testing waterproof property of an object by measuring a differential pressure is known. This waterproof test method will be described with reference to FIG. 11. FIG. 11 is a drawing which illustrates a configuration of an air-tightness test apparatus 4 which tests air-tightness by measuring a differential pressure. As illustrated in FIG. 11, the air-tightness test apparatus 4 includes a test apparatus main body 41, storage containers 42a and 42b, and air hoses 43a and 43b.

The storage container 42a is a container for storing a test object 5, and is connected to the test apparatus main body 41 via the air hose 43a. The storage container 42b is a container for storing a master 6 having the same volume as the test object 5, and is connected to the test apparatus main body 41 via the air hose 43b.

When performing an air-tightness test, first, the test apparatus main body 41 injects the same amount of gas into the storage containers 42a and 42b via the air hoses 43a and 43b. Here, if the test object 5 has a problem regarding air-tightness, the gas pressure in the storage container 42a decreases depending on the severity of the problem because the gas injected into the container 42a penetrates into the inside of the test object 5.

Next, the test apparatus main body 41 measures a differential pressure between the gas pressure in the storage container 42a and the gas pressure in the storage container 42b. Here, if the gas pressure in the storage container 42a is lower than the gas pressure in the storage container 42b by a predetermined threshold value or more, it is determined that the test object 5 has a problem regarding air-tightness.

[Patent Document 1] Japanese Laid-open Patent Publication No. 2002-310842.

However, the conventional air-tightness test method described above has a problem in that accurately measuring the air-tightness is difficult when the internal volume of the test object is small. When the internal volume of the test object is small, the amount of gas penetrating into the inside of the test object is small even if the test object has a problem regarding air-tightness. Therefore, even when the test object has a problem regarding air-tightness, only a small amount of differential pressure can be detected, so that it is difficult to determine whether the differential pressure is caused by the air-tightness problem or another reason.

### SUMMARY

According to an aspect of an embodiment, a method for testing waterproof property of an object designed to prevent water from penetrating into the inside of the object and having a hole, the hole allowing air communication between the inside and the outside of the object, the method includes: attaching closely to the object a tank having an opening hermetically surrounding the hole to form an air communication path between the inside of the object and the tank to form a single air tight space; placing the object to which the tank is attached in an air tight container; either or both of injecting gas into and extracting the air from the air tight container containing the object so as to change the gaseous pressure of the air tight container; and measuring an internal gaseous pressure of the air tight container to determine whether the waterproof property of the object is effective or not.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a drawing illustrating a mobile terminal apparatus used when an air-tightness test according to this embodiment is performed.

FIG. 2 is a plan view of a virtual tank.

FIG. 3 is a cross-sectional view taken along line III-III of the virtual tank illustrated in FIG. 2.

FIG. 4 is a plan view of a movable-side housing to which the virtual tank is closely attached.

FIG. 5 is a cross-sectional view taken along line V-V of the movable-side housing illustrated in FIG. 4.

FIG. 6 is an enlarged view of a portion around a hole of the movable-side housing illustrated in FIG. 5.

FIG. 7 is a diagram illustrating the slope of a jig used in the air-tightness test according to this embodiment.

FIG. 8 is a perspective view of the mobile terminal apparatus sandwiching the jig illustrated in FIG. 7.

FIG. 9 is an illustration illustrating an operation in which the mobile terminal apparatus sandwiching the jig is being placed into the storage container 42a.

FIG. 10 is a flowchart illustrating a processing procedure of the air-tightness test method according to this embodiment.

FIG. 11 is an illustration illustrating a configuration of an air-tightness test apparatus.

### DESCRIPTION OF EMBODIMENT

Hereinafter, an embodiment of the method for testing waterproof property of an object (the air-tightness test method) and waterproof test tool disclosed in this application will be described with reference to the accompanying drawings. Although, in the embodiment described below, an example for testing waterproof of a movable-side housing of a mobile terminal apparatus will be described, an application of the waterproof test method and waterproof test tool disclosed in this application is not limited to this.

An object of the disclosed technique is to provide an waterproof test method and an waterproof test tool which enable determination of waterproof with a high degree of accuracy even when the internal volume of the test object is small.

According to an aspect of the waterproof test method and waterproof test tool disclosed in this application, there is an advantage that air-tightness can be measured with a high degree of accuracy.

First, a tool used in the waterproof test method according to this embodiment, and a mobile terminal apparatus which is an example of a test object whose air-tightness is measured by using the tool will be described.

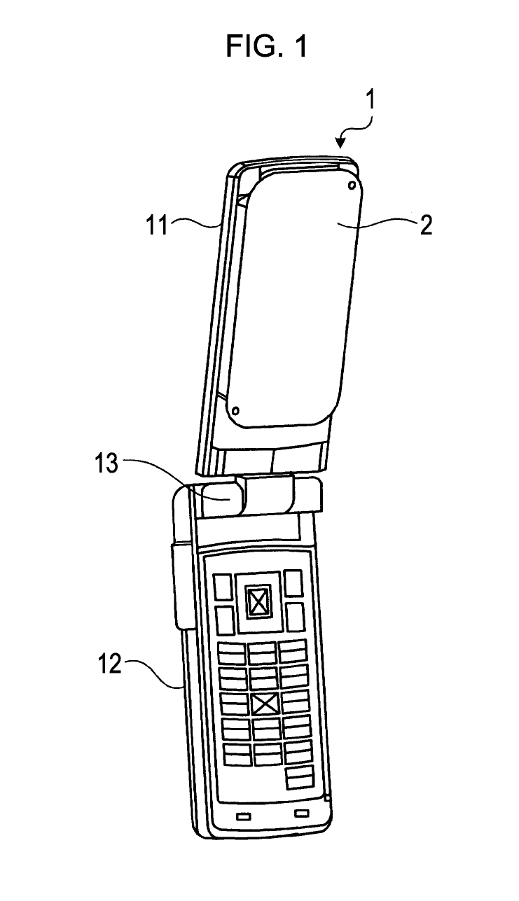

FIG. 1 is a drawing illustrating a mobile terminal apparatus used when the waterproof test according to this embodiment is performed. In the mobile terminal apparatus 1 illustrated in FIG. 1, a movable-side housing 11 having an LCD (Liquid Crystal Display) panel not illustrated in the figure and a fixed-side housing 12 having various operation keys are foldably connected by a hinge section 13. The mobile terminal apparatus 1 is designed to prevent water from penetrating into the inside of the mobile terminal apparatus 1. Here, although a mobile phone is illustrated as an example of the mobile terminal apparatus, the mobile terminal apparatus 1 may be a mobile information processing apparatus such as a PDA (Personal Digital Assistant) or the like. The waterproof test is realized by measuring internal gaseous pressure of the air tight container which the mobile terminal apparatus 1 is placed in. Therefore, the waterproof test is called air-tightness test below.

The movable-side housing 11 and the fixed-side housing 12 have a waterproof design so that water does not penetrate into the inside, and their waterproof performance is tested in the manufacturing process. In this waterproof performance test, if water is actually used, the water penetrates into a product when the product has a problem of waterproof performance, and it becomes difficult to repair the product. Therefore, the waterproof performance test is carried out as an air-tightness test which measures a differential pressure.

However, since mobile terminal apparatuses in recent years are becoming smaller and thinner, and their inside volumes are becoming smaller; it is difficult to measure air-tightness with a high degree of accuracy in conventional air-tightness test methods. Therefore, in the air-tightness test method according to this embodiment, a virtual tank 2 which is a tool for improving the determination accuracy of the air-tightness test is used.

In the example illustrated in FIG. 1, the virtual tank 2 is attached to the movable-side housing 11. The virtual tank 2 is formed so that a space is formed between the virtual tank 2 and the movable-side housing 11 by attaching the virtual tank 2 closely to the movable-side housing 11. By integrating the space with a space inside the movable-side housing 11, the space inside the movable-side housing 11 can be virtually expanded, and the determination accuracy of the air-tightness test can be improved.

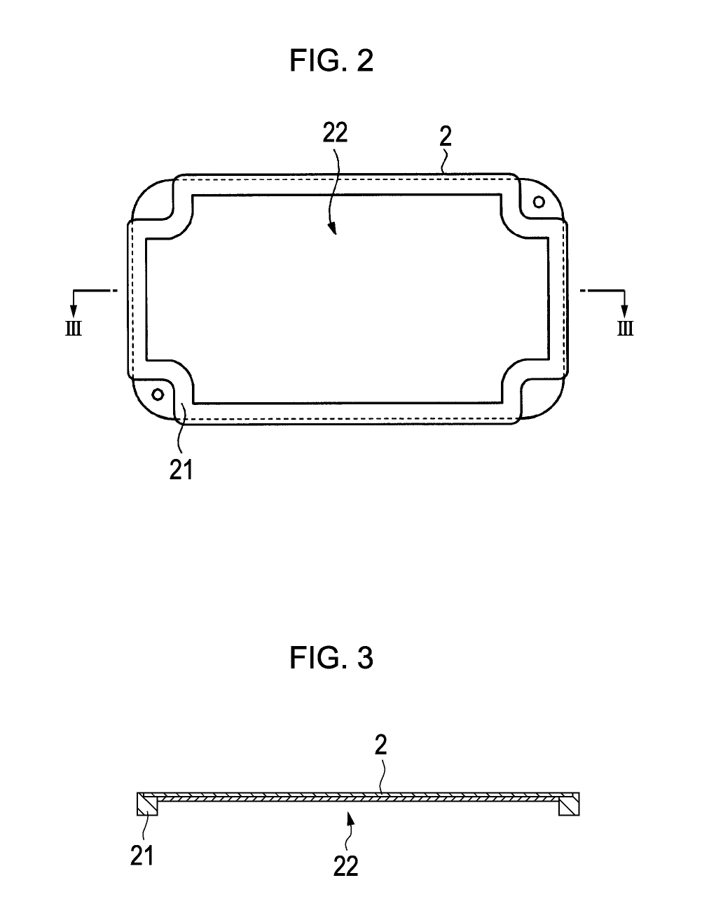

Here, a shape of the virtual tank 2 will be described with reference to FIGS. 2 and 3. FIG. 2 is a plan view of the virtual tank 2, and FIG. 3 is a cross-sectional view taken along line III-III of the virtual tank 2 illustrated in FIG. 2. As illustrated in FIGS. 2 and 3, in the virtual tank 2, a concave section 22 is formed inside an opening section 21. Therefore, in the virtual tank 2, the concave section 22 forms a hollow space by closely attaching the opening section 21 to the movable-side housing 11 hermetically, the opening section 21 surrounding a hole 114.

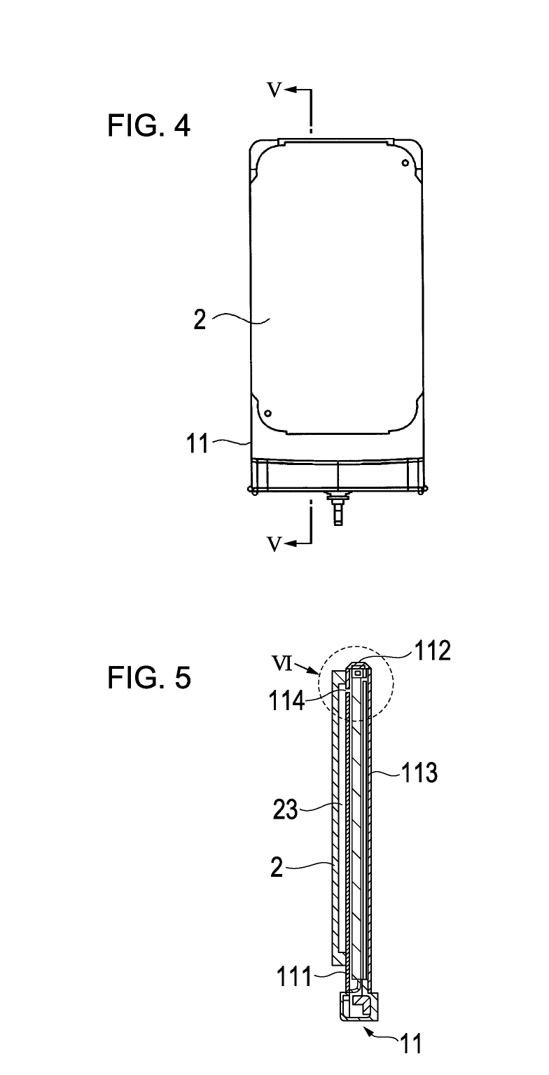

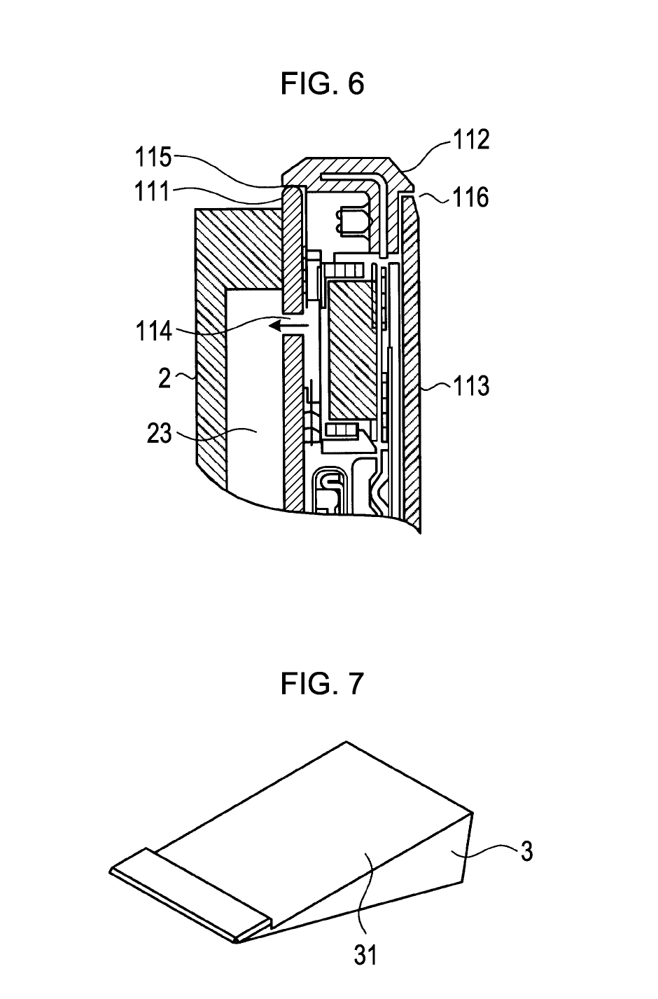

Next, a usage of the virtual tank 2 will be described with reference to FIGS. 4 to 6. FIG. 4 is a plan view of the movable-side housing 11 to which the virtual tank 2 is closely attached, FIG. 5 is a cross-sectional view taken along line V-V of the movable-side housing 11 illustrated in FIG. 4, and FIG. 6 is an enlarged view of a portion VI around a hole 114 of the movable-side housing 11 illustrated in FIG. 5.

As illustrated in FIG. 5, the surface of the movable-side housing 11 is configured by combining surface panels 111 to 113 and the like. The surface panel 111 is a transparent flat panel for protecting the LCD panel provided inside the movable-side housing 11 and allowing checking of contents displayed on the LCD panel. In the surface panel 111, the hole 114 for making a caller's voice easier to reach the outside during verbal communication is provided.

Although waterproof processing is performed on the hole 114 in a later process, in a phase of the air-tightness testing process, the space inside the movable-side housing 11 is connected to the outside space via the hole 114. The virtual tank 2 is closely attached to the surface panel 111 so that the opening section 21 surrounds the hole 114.

The opening section 21 has a width and a length smaller than or approximately equal to those of the surface panel 111, and is formed flatly in the same way as the surface panel 111. Therefore, when the virtual tank 2 is closely attached to the surface panel 111, the opening section 21 contacts the surface panel 111 without a gap. Therefore, gas in a space 23 formed between the virtual tank 2 and the surface panel 111 does not leak from between the opening section 21 and the surface panel 111.

As illustrated in FIG. 6, the space 23 is integrated with the space inside the movable-side housing 11 via the hole 114, so that the space inside the movable-side housing 11 is virtually expanded. The virtual expansion of the space inside the movable-side housing 11 improves the determination accuracy of the air-tightness test as described below.

Although waterproof processing is performed on a joint 115 between the surface panel 111 and the surface panel 112, and a joint 116 between the surface panel 112 and the surface panel 113, these joints are not covered by the virtual tank 2. Therefore, if there is a problem in waterproof processing on the joint 115 or the joint 116, the gas injected into the storage container 42a in the air-tightness test penetrates into the inside of the movable-side housing 11. A part of the gas that penetrated into the inside of the movable-side housing 11 penetrates into the space 23 via the hole 114.

In this way, a space inside a test object is virtually expanded by using a tool such as the virtual tank 2, so that an amount of gas penetrating into the test object having a problem regarding air-tightness or waterproof performance increases. As a result, even though a space inside the test object having a problem regarding air-tightness or waterproof performance is small, a large differential pressure is detected and the determination accuracy of the air-tightness test improves.

The shape of the virtual tank 2 illustrated in FIG. 2 is an example, and the shape of the tool for virtually expanding a space inside a test object in the air-tightness test method disclosed in this application is not limited to this. Specifically, the tool for virtually expanding a space inside a test object may have any shape if the shape has an opening section to be closely attached to the test object so that the opening section surrounds a hole connecting the inside of the test object with the outside and the shape forms another space to be integrated with the space inside the test object by closely attaching the opening section to the test object.

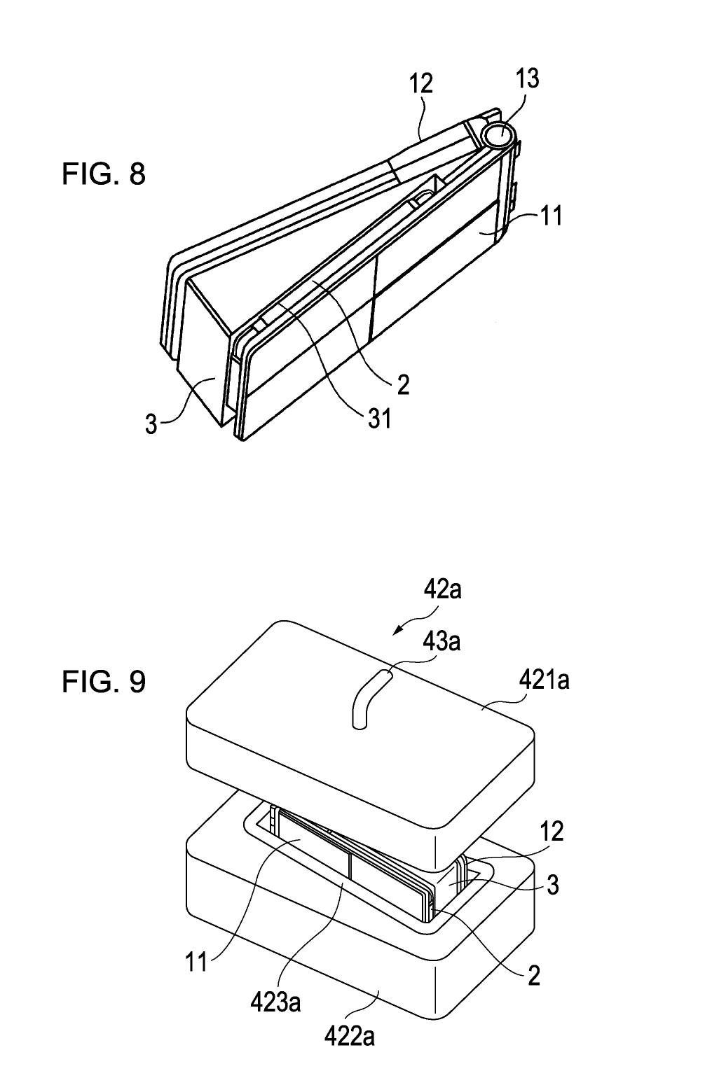

Next, a jig used in the air-tightness test method according to this embodiment will be described with reference to FIGS. 7 to 9. FIG. 7 is a diagram illustrating the slope of the jig 3 used in the air-tightness test according to this embodiment, FIG. 8 is a perspective view of the mobile terminal apparatus 1 sandwiching the jig 3 illustrated in FIG. 7, and FIG. 9 is an illustration illustrating an operation in which the mobile terminal apparatus 1 sandwiching the jig 3 is being placed into the storage container 42a.

Since the mobile terminal apparatus 1 is foldable, when it is left open, the size thereof is large and it is difficult to place the mobile terminal apparatus 1 in the storage container 42a. On the other hand, as illustrated in FIG. 1, when folding the mobile terminal apparatus 1 to which the virtual tank 2 is attached, one of the sides of the virtual tank 2 interferes with the fixed-side housing 12, so that it is impossible to completely fold the mobile terminal apparatus 1.

When the mobile terminal apparatus 1 is incompletely folded, if some external force works on the movable-side housing 11 or the fixed-side housing 12, the external force may concentrate on the side of the virtual tank 2 which interferes with the fixed-side housing 12, so that there is a risk that the virtual tank 2 detaches from the movable-side housing 11. In addition, depending on the position where the virtual tank is attached, the angle between the movable-side housing 11 and the fixed-side housing 12 in a folded state varies, so that the shape of the mobile terminal apparatus 1 varies. The variation in the shape leads to a variation in volume, which affects the pressure in the storage container in the air-tightness test, so that the variation in the shape may deteriorate the determination accuracy.

To solve this problem, the wedge-shaped jig 3 as illustrated in FIG. 7 is used in the air-tightness test according to this embodiment. A level difference 31 having a shape which can accommodate the virtual tank 2 is formed in the jig 3. When folding the mobile terminal apparatus 1 with the jig 3 sandwiched therein so that the virtual tank 2 is accommodated within the level difference 31, the mobile terminal apparatus 1 appears as illustrated in FIG. 8.

As illustrated in FIG. 9, the mobile terminal apparatus 1 with the virtual tank 2 attached and the jig 3 sandwiched therein is folded and placed in the storage container 42a, and the air-tightness test is performed. As illustrated in FIG. 9, the storage container 42a is configured to be separable into an upper container 421a and a lower container 422a, and a resin 423a is embedded on the inner surface of the storage container 42a in order to improve air-tightness.

As illustrated in FIG. 8, when folding the mobile terminal apparatus 1 with the jig 3 sandwiched therein, the virtual tank 2 is accommodated in the level difference 31. Therefore, even if some external force works on the movable-side housing 11 or the fixed-side housing 12, there is no risk that the external force works on only a part of the housings. In addition, since the angle between the movable-side housing 11 and the fixed-side housing 12 in the folded state is constant because of the jig 3, there is no risk that the variation in volume deteriorates the determination accuracy.

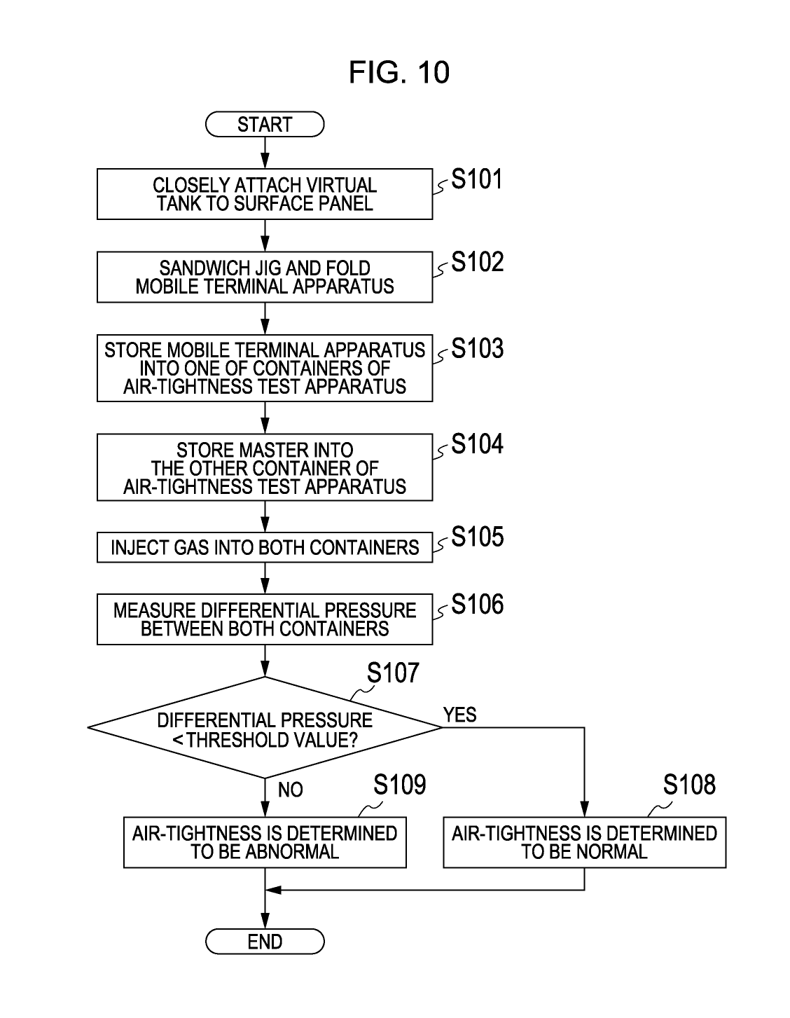

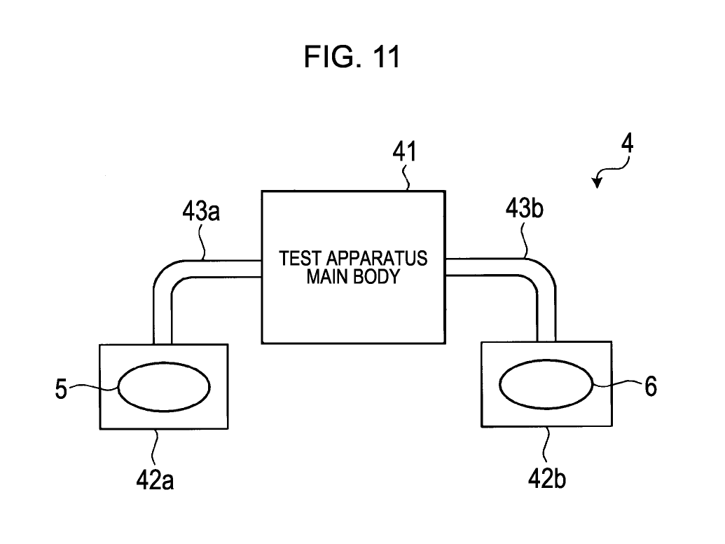

Next, a processing procedure of the air-tightness test method according to this embodiment will be described. FIG. 10 is a flowchart illustrating the processing procedure of the air-tightness test method according to this embodiment. First, as illustrated in FIG. 10, the virtual tank 2 is closely attached to the surface panel 111, and the space 23 to be integrated with the space inside the movable-side housing 11 is formed between the virtual tank 2 and the surface panel 111 (step S101).

Next, the mobile terminal apparatus 1 is folded with the jig 3 sandwiched therein (step S102). Thereafter, the mobile terminal apparatus 1 is placed in the storage container 42a of the air-tightness test apparatus 4 (step S103), and a master having the same volume as that of the mobile terminal apparatus 1 with the virtual tank 2 attached and the jig 3 sandwiched therein is placed in the storage container 42b (step S104). The master may be placed in the storage container 42b in advance.

Next, gas is injected into the container 42a and the container 42b (step S105) so as to increase the gaseous pressure of the container 42a and the container 42b, and a differential pressure between the internal pressures of the container 42a and the container 42b is measured (step S106). Gas may be extracted from the container 42a and the container 42b so as to decrease the gaseous pressure of the container 42a and the container 42b, and a differential pressure between the internal pressures of the container 42a and the container 42b is measured. When the differential pressure is smaller than a predetermined threshold value (step S107: Yes), the air-tightness is determined to be normal, i.e. the waterproof property of the mobile terminal apparatus 1 is effective (step S108), and when the differential pressure is greater than the predetermined threshold value (step S107: No), the air-tightness is determined to be abnormal, i.e. the waterproof property of the mobile terminal apparatus 1 is not effective (step S109).

The air-tightness test method can be also realized without using the master having the same volume as that of the mobile terminal apparatus 1. First, the virtual tank 2 is closely attached to the surface panel 111, and the space 23 to be integrated with the space inside the movable-side housing 11 is formed between the virtual tank 2 and the surface panel 111.

Next, the mobile terminal apparatus 1 is folded with the jig 3 sandwiched therein. Thereafter, the mobile terminal apparatus 1 is placed in the storage container 42a of the air-tightness test apparatus 4.

Next, gas is injected into the container 42a, and an internal pressure of the container 42a is measured for a predetermined length of time. Gas may be extracted from the container 42a so as to decrease the gaseous pressure of the container 42a, and the internal pressures of the container 42a is measured. When the internal pressure changes and becomes smaller than a predetermined threshold value, the waterproof property (air-tightness) of the mobile terminal apparatus 1 is determined to be not effective.

As described above, in this embodiment, since the air-tightness is tested by virtually expanding a space inside the test object, air-tightness can be determined with a high degree of accuracy.

All examples and conditional language recited herein are intended for pedagogical purposes to aid the reader in understanding the invention and the concepts contributed by the inventor to furthering the art, and are to be construed as being without limitation to such specifically recited examples and condition, nor does the organization of such examples in the specification relate to a showing of superiority and inferiority of the invention. Although the embodiment of the present inventions have been described in detail, it should be understood that the various changes, substitutions, and alternations could be made hereto without departing from the spirit and scope of the invention.

What is claimed is:

1. A method for testing waterproof property of an object designed to prevent water from penetrating into the inside of the object and having a hole, the hole allowing air communication between the inside and the outside of the object, the method comprising:
attaching closely to the object a tank having an opening hermetically surrounding the hole to form an air communication path between the inside of the object and the tank to form a single air tight space;
placing the object to which the tank is attached in an air tight container;
either or both of injecting gas into and extracting the air from the air tight container containing the object so as to change the gaseous pressure of the air tight container; and
measuring an internal gaseous pressure of the air tight container to determine whether the waterproof property of the object is effective or not.

2. The method according to claim 1, wherein the object is a mobile terminal apparatus which is foldable and the mobile terminal apparatus to which the tank is attached is contained in the container with sandwiching a jig in the placing process, the jig forming a level difference to accommodate the tank.

3. A tank being attachable an object and used for testing waterproof property of an object designed to prevent water from penetrating into the inside of the object and having a hole, the hole allowing air communication between the inside and the outside of the object, the tank comprising:
an opening closely attached to the object hermetically surrounding the hole to form an air communication path between the inside of the object and the tank to form a single air tight space; and
a concave section forming a hollow space by bridging between the inside and the outside of the object and via the hole of the object.
